(19) United States
(12) Patent Application Publication
(10) Pub. No.: US 2024/0185231 A1
(43) Pub. Date: Jun. 6, 2024

(54) SYSTEMS AND METHODS FOR EFFICIENT TRANSACTION PROCESSING

(71) Applicant: U.S. Bancorp, National Association, Minneapolis, MN (US)

(72) Inventors: Sean B. Kelley, Oak Park, IL (US); Andrew L. Hosford, Cicero, IL (US)

(73) Assignee: U.S. Bancorp, National Association, Minneapolis, MN (US)

(21) Appl. No.: 18/074,086

(22) Filed: Dec. 2, 2022

(51) Int. Cl. G06Q 20/38; G06F 9/48; G06Q 20/32

(52) U.S. Cl. CPC G06Q 20/38; G06F 9/4825; G06Q 20/325

(57) ABSTRACT

A method comprises storing a plurality of potential transactions, each potential transaction comprising one or more transaction attributes; receiving a selection of a set of values for the one or more transaction attributes; selecting, using an optimization engine, a set of potential transactions from the plurality of potential transactions according to an optimization function and the selection of the set of values; detecting a defined time on an internal clock maintained by the processor; responsive to detecting the defined time, iteratively executing the optimization engine removing a different potential transaction from the set of potential transactions for each execution; and generating a record comprising a ranking for each potential transaction of the set of potential transactions according to the iterative executions.

### BACKGROUND

Processing transactions and potential transactions can require a significant amount of computer resources. The processing resources required to process such transactions can compound when using processing resources to select which potential transactions to identify for processing, particularly when a computer processes thousands of permutations of potential transactions to select a set of potential transactions (e.g., a single permutation of the thousands of permutations) that satisfy defined criteria. Selecting a set of potential transactions to process or identify for potential processing while complying with defined criteria can require a large amount of computer memory resources and time, in some cases requiring hours for the computer to identify potential transactions for processing.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an illustration of an example system for efficient transaction processing, in accordance with an implementation;

FIGS. 2A-2C are illustrations of example methods for efficient transaction processing, in accordance with an implementation;

FIG. 3 is an illustration of an example sequence for efficient transaction processing, in accordance with an implementation;

FIGS. 4A and 4B are illustrations of example user interfaces for selecting matching transactions, in accordance with an implementation;

FIGS. 5A and 5B are illustrations of example user interfaces for identifying transactions, in accordance with an implementation; and

FIG. 6 is an illustration of a list of available transactions, in accordance with an implementation.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

As previously mentioned, transaction processing infrastructures can often be overburdened when processing data for a large number of potential transactions. For example, a system may be configured to identify a set of potential transactions that optimize constraints of an optimization function. The system may be configured to do so by executing an optimization engine using transaction attributes of a number of potential transactions as input. The system may configure the optimization function to comply with set criteria, such as constraints and bounds for the transaction attributes. The optimization engine may output a list of potential transactions that satisfy the criteria. However, the system may not have any way to differentiate between the potential transactions that have the highest impact on the optimization of the set of potential transactions and the potential transactions that have a lower impact.

Implementations of the systems and methods discussed herein overcome these technical deficiencies because they provide a method for executing an optimization engine to determine rankings for an optimized set of potential transactions. A computer implementing the systems and methods described herein can do so by executing an optimization engine once using each potential transaction that the computer stores in a database. The optimization engine may be configured according to a set of criteria, such as criteria including constraints for different transaction attributes. The optimization engine may output a set of potential transactions that optimize the optimization function according to the execution and the criteria. The optimization engine may also output a value for the set of potential transactions. The computer may record or store the value in memory. The computer may then iteratively execute the optimization engine using the potential transactions as input except removing a different potential transaction from the set of potential transactions for each iterative execution. The optimization engine may output a value for each iterative execution. The computer may store the value with an association with the potential transaction the computer removed from the set of potential transactions. The computer may calculate differences between the value for the entire set of potential transactions and a value for each individual potential transaction. The computer may rank the potential transactions in descending or ascending order according to the differences that correspond to the potential transactions. In this way, the computer may use an optimization engine to both generate a set of potential transactions and rank each potential transaction of the set according to the effect the potential transaction had on solving the optimization function of the optimization engine.

Determining the rankings for the potential transactions of the set of potential transactions can require a large amount of computing resources. For example, the optimization engine may output a large number of potential transactions in the set of potential transactions. Accordingly, when the computer executes the optimization iteratively for each potential transaction of the set of potential transactions, the computer may use a large amount of memory and processing power as well as use a large amount of time.

To overcome the aforementioned technical deficiencies, the computer may implement different processing techniques. In one example, the computer may implement a batch processing technique to perform the iterative executions. The computer may maintain a clock and monitor the clock for a defined time. The computer may identify the defined time on the clock and perform the iterative executions to determine rankings for the potential transactions. The defined time may be late in the day, such as after 9 PM. By using such batch processing techniques, the computer may conserve resources for the processing during times in which the computer is not using computing resources for other activities. Thus, the computer may allocate more resources to the processing of the optimization engine for ranking potential transactions to times in which more resources are available and/or without inhibiting the computer from performing other processes.

In another example, the computer may implement parallel processing techniques to perform the iterative executions. For example, after generating a list of a set of potential transactions, the computer may transmit the list to one or more other computing devices. The computer may transmit identifications of a different subset of potential transactions from the set of potential transactions to each of the computing devices. In some cases, the computer may transmit criteria to the computing devices that match the criteria the computer used to configure the optimization engine executed by the computer. Each of the computing devices may receive the identifications of the subset of computing devices as well as the criteria. The computing devices may each configure an optimization engine stored locally at the computing device according to the received criteria. The computing devices may iteratively execute the optimization engines stored locally in memory at the computing devices, for each iteration removing a potential transaction of the subset of potential transactions for which the respective computing devices received an identification. The computing devices may iteratively execute the optimization engines stored locally in a similar manner to the batch processing technique described above to determine values for the individual potential transactions of the respective subsets of potential transactions. The computing devices may transmit the values back to the computer. The computer may determine differences for the potential transactions based on the received values and rank the potential transactions accordingly. In this way, the computer may implement parallel processing techniques to efficiently process a large number of potential transactions and reduce the amount of time such processing may require.

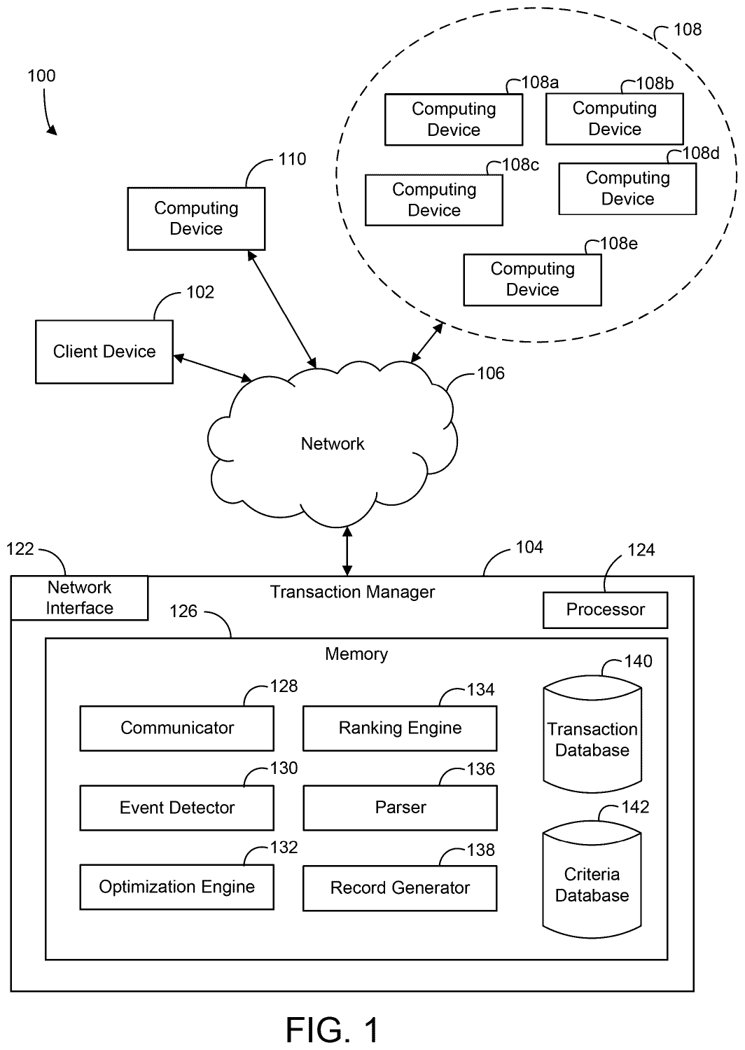

FIG. 1 illustrates an example system 100 for efficient transaction processing, in some embodiments. In brief overview, the system 100 can include a client device 102 that communicates with a transaction manager 104 over a network 106. Client device 102 can transmit the transaction manager 104 requests for identifications of potential transactions. The client device 102 can transmit the transaction manager 104 one or more values for transaction attributes in a request. The transaction manager 104 can receive the request and/or the values and select a set of potential transactions that satisfy an optimization function according to the one or more values (e.g., constraints) of the request. The transaction manager 104 can rank the potential transactions in the set using batch processing techniques and/or parallel processing techniques (e.g., by communicating with the computing devices 108a-e (collectively computing devices 108)). The transaction manager 104 can transmit the ranked potential transactions to the client device 102. The client device 102 can present the ranked potential transactions on a user interface. The transaction manager 104 may match the selected potential transactions with available transactions the transaction manager 104 receives from a computing device 110. The transaction manager 104 may present the matching transaction at the client device 102. The client device 102 can facilitate transactions selected from the matched transactions with the computing device 110. The system 100 may include more, fewer, or different components than shown in FIG. 1. For example, there may be any number of client devices or computers that make up or are a part of the transaction manager 104 or networks in the system 100.

The client device 102, the transaction manager 104, the computing devices 108, and/or the computing device 110 can each include or execute on one or more processors or computing devices and/or communicate via the network 106. The network 106 can include computer networks such as the Internet, local, wide, metro, or other area networks, intranets, satellite networks, and other communication networks such as voice or data mobile telephone networks. The network 106 can be used to access information resources such as web pages, websites, domain names, or uniform resource locators that can be presented, output, rendered, or displayed on at least one computing device (e.g., the client device 102), such as a laptop, desktop, tablet, personal digital assistant, smartphone, portable computers, or speaker. For example, via the network 106, the client device 102 can transmit requests to the transaction manager 104. The transaction manager 104 can select and rank sets of potential transactions that the client device 102 can select for execution.

The client device 102, the transaction manager 104, the computing devices 108, and/or the computing device 110 can include or utilize at least one processing unit or other logic devices such as a programmable logic array engine or a module configured to communicate with one another or other resources or databases. The components of the client device 102, the transaction manager 104, the computing devices 108, and/or the computing device 110 can be separate components or a single component. The system 100 and its components can include hardware elements, such as one or more processors, logic devices, or circuits.

The computing devices 108 may include computers similar to the client device 102 and/or the transaction manager 104. For example, each of the computing devices 108 can include the same or similar components to the client device 102 and/or the transaction manager 104. The computing devices 108 may each store an optimization engine that the computing devices 108 can configure according to set constraints and/or other criteria. The optimization engines of the computing devices 108 may be configured similar to an optimization engine 132 stored in the transaction manager 104 as described below.

The transaction manager 104 may comprise one or more processors that are configured to execute an optimization engine to select and rank potential transactions in accordance with values for different transaction attributes. The transaction manager 104 may comprise a network interface 122, a processor 124, and/or memory 126. The transaction manager 104 may communicate with the client device 102 and, in some cases, the computing devices 108 via the network interface 122. The network interface 122 may be or include an antenna or other network device that enables communication across a network and/or with other devices. The processor 124 may be or include an ASIC, one or more FPGAs, a DSP, circuits containing one or more processing components, circuitry for supporting a microprocessor, a group of processing components, or other suitable electronic processing components. In some embodiments, the processor 124 may execute computer code or modules (e.g., executable code, object code, source code, script code, machine code, etc.) stored in the memory 126 to facilitate the activities described herein. The memory 126 may be any volatile or non-volatile computer-readable storage medium capable of storing data or computer code.

The memory 126 may include a communicator 128, an event detector 130, the optimization engine 132, a ranking engine 134, a parser 136, a record generator 138, a transaction database 140, and/or a criteria database 142, in some embodiments. In brief overview, the components 128-140 may cooperate to receive a request for transaction identifications. The request may include values for transaction attributes. The components 128-140 may execute an optimization engine to select and rank a set of potential transactions that satisfy the values. The components 128-140 may communicate with the requesting client device and the computing device 110 to facilitate transactions from the set of potential transactions identified by a user input at the requesting client device.

The transaction manager 104 may store one or more potential transactions in the transaction database 140. The transaction database 140 may be or include a relational database. The transaction database 140 may store potential transactions that are hosted or otherwise associated with different financial institutions. The transaction database 140 may store the potential transactions by storing the potential transactions with values for different transaction attributes. Examples of transaction attributes include, but are not limited to, a value of the transaction, a percentage associated with the transaction, a size, a credit quality, a risk of loss, and/or a priority to cash flow distributions. Other transaction attributes may be or include an identification of the transaction (e.g., a number string or an alphanumeric string), an identifier of a financial institution hosting the transaction, a binary indication of whether the transaction is associated with an agent, a facility of the transaction, and/or an issuer of the transaction. The transaction database 140 may store a value for one or more of such transaction attributes in attribute-value pairs for each potential transaction of the transaction database 140 stores. The transaction manager 104 may initially store the potential transactions with attribute-value pairs with blank values in the entries for the respective potential transactions. The transaction manager 104 may then add values to the attribute-value pairs as the transaction manager 104 receives inputs (e.g., user inputs) indicating the values. The transaction manager 104 may add the values to the attribute-value pairs by updating the respective entries with the values.

The transaction database 140 may include one or more databases (e.g., databases in a distributed system). The transaction database 140 may store potential transactions for different individual issuers and/or financial institutions. Each potential transaction may be stored as an entry in the transaction database 140 that includes one or more attribute-value pairs as described above. The transaction manager 104 may update the potential transaction in the transaction database 140 over time as the transaction manager 104 receives new values for the potential transactions.

The transaction manager 104 may store one or more criteria in the criteria database 142. The criteria database 142 may be or include a relational database. The criteria database 142 may store criteria for sets of potential transactions that can be stored and/or performed for a particular account or profile (e.g., an account or profile for an individual or group entity). For example, the criteria database 142 may store criteria that are set (e.g., input) by the individuals or group entities that are associated with individual accounts of the transaction manager 104. The criteria may include one or more constraints for a potential transaction. The constraints may indicate one or more maximum and/or minimum values for a set of potential transactions for an individual, such as a maximum and/or minimum risk profile or credit. The constraints may indicate values for a set of potential transactions taken in the aggregate (e.g., a maximum average or summation calculated across each transaction in the set of potential transactions). An administrator may set constraints to be the same across each account for which the transaction manager 104 stores and/or manages sets of potential transactions.

The transaction database 140 may store transactions (e.g., held or owned transactions) in addition or instead of potential transactions. For example, the transaction database 140 may store transactions for accounts associated with (e.g., owned by) different individuals or group entities. The transaction database 140 may store the transactions in data structures (e.g., entries) that correspond to the respective accounts. The transaction manager 104 may use the transactions stored in the accounts to determine which potential transactions to identify for an account in response to a request (e.g., determine which potential transactions to identify for an account based on the transaction attributes of the transactions already stored for the account).

The criteria database 142 may store criteria that are specific to each individual account. The account-specific criteria may be unique to each individual account. The account-specific criteria may be or include values for different transaction attributes. The criteria database 142 may store the criteria in accounts or profiles that correspond to the criteria for the respective accounts or profiles. The transaction manager 104 may receive criteria from client devices associated with (e.g., accessed by) individuals or group entities associated with the respective accounts. The transaction manager 104 may identify the accounts in the criteria database 142 that correspond with the individuals or group entities transmitting the criteria (e.g., values for different transaction attributes). The transaction manager 104 may store the transmitted or received criteria in the identified accounts. Accordingly, the criteria database 142 may store criteria that correspond to individuals and/or group entities. The transaction manager 104 may use the criteria from an account upon receiving a request for identifications of potential transactions from an individual associated with the account.

In some embodiments, the data described as being stored in the transaction database 140 and the criteria database 142 are stored in the same database. For example, the transaction manager 104 may store a database in the memory 126 that includes individual data structures for different accounts. In each data structure, the transaction manager 104 may store criteria and transactions for the account in the data structure. The transaction manager 104 may retrieve criteria and/or transactions for an account when determining which potential transactions to identify for the account.

The communicator 128 may comprise programmable instructions that, upon execution, cause the processor 124 to communicate with client devices (e.g., the client device 102) and/or computing devices 108 and 110. The communicator 128 may be or include an application programming interface (API) that facilitates communication between the transaction manager 104 and other computing devices. The communicator 128 may communicate with the client devices and/or computing devices across the network 106.

The communicator 128 can receive a request. The request can be a request for identifications of potential transactions for an account. The request can include an identification of the account (e.g., a numeric or alphanumeric identifier) and a selection of a set of values for one or more transaction attributes. The communicator 128 can receive the request from the client device 102 over the network 106. The client device 102 may access a platform that the communicator 128 provides to the client device 102 over the network 106. The client device 102 may transmit a request in a network packet or message to the communicator 128 via the platform. For example, via the client device 102, a user may access the user's account on the platform that the communicator 128 provides. The user may select (e.g., input or select from a user interface) one or more values for transaction attributes from a user interface of the platform. The client device 102 may receive the selection of values, encapsulate the selection of values into one or more network packets, and transmit the one or more network packets to the transaction manager 104.

The optimization engine 132 may comprise programmable instructions that, upon execution, cause the processor 124 to generate a list of potential transactions that conform to defined criteria for one or more transaction attributes. The optimization engine 132 may retrieve potential transactions, including transaction attributes of the potential transactions, from the transaction database 140. The optimization engine 132 may input the set of values the communicator 128 received in the request into an optimization function (e.g., gradient descent, momentum, Adagrad, root mean squared propagation, Adam, technique for order of preference by similarity to ideal solution (TOPSIS), etc.). The optimization engine 132 can configure the optimization function such that the set of values are the constraints of the optimization function. The optimization engine 132 can input the transaction attributes of the potential transactions the optimization engine 132 retrieved from the transaction database 140 into the optimization function. The optimization engine 132 can execute the optimization function according to the configuration and the input transaction attributes. The optimization engine 132 can determine a set of potential transactions that optimizes a value for the set values and that satisfy the criteria that set the parameters for the optimization function.

The optimization engine 132 may configure the optimization function of the optimization engine 132 according to different types of criteria (e.g., criteria from different sources). For example, the optimization engine 132 may configure the optimization function according to the values (e.g., constraints) for transaction attributes the transaction manager 104 received in the request. The optimization engine 132 may additionally or instead configure the optimization function according to values that correspond to an account associated with the individual or group entity that transmitted the request (e.g., the optimization engine 132 may identify the individual or group entity that transmitted the request from an identifier in the request or based on an account the individual or group entity used to access the platform provided by the transaction manager 104 and retrieve criteria that corresponds to the individual or group entity from the criteria database 142 based on the identifier or the account). The optimization engine 132 may additionally or instead configure the optimization function according to criteria the criteria database 142 stores to apply to each account or execution of the optimization engine 132. Accordingly, the optimization engine 132 may be configured to comply with different user preferences and/or regulations.

The optimization engine 132 may execute an optimization function using similar methods to those described in U.S. patent application Ser. No. 17/528,0971, filed Nov. 16, 2020, the entirety of which is incorporated by reference herein. For example, the optimization engine 132 may use linear proxy constraints for non-linear constraints based on the criteria the optimization engine 132 retrieves from the criteria database 142 from the request. The optimization engine 132 may execute a system of equations with the linear proxy constraints for non-linear constraints to output a set of potential transactions. The optimization engine 132 may determine whether the output is feasible (e.g., optimizes the optimization function). Responsive to determining the output is feasible, the optimization engine 132 may determine whether the output satisfies a convergence criterion based on determining whether the output satisfies the input criteria. Responsive to determining the output is not feasible or does not satisfy the convergence criterion, the optimization engine 132 may adjust input settings (e.g., maximum number of transactions to execute, a maximum number of buys to execute, a maximum number of sells to execute, etc.). The optimization engine 132 may repeat this process until identifying a set of potential transactions that satisfy the optimization function according to the criteria.

In some embodiments, the optimization engine 132 can input transactions (e.g., already executed transactions) that correspond to the account into the optimization function. For example, the optimization engine 132 may use the identification of the account received in the request to query the transaction database 140. The optimization engine 132 may identify transactions that correspond to the account based on the transactions corresponding to a matching identification to the identification of the request. The optimization engine 132 may execute the optimization function using the transaction attributes that correspond to the retrieved transactions as input. In the optimization function, the transaction attributes that correspond to the retrieved transactions may operate as fixed transaction attributes, set such that the retrieved transactions are already selected and the potential transactions that the optimization engine 132 selects satisfy the input criteria assuming the transactions of the transactions are selected.

The optimization engine 132 may select the set of potential transactions that the optimization engine 132 selected as satisfying the optimization function. For example, the optimization engine 132 may record (e.g., mark in memory) or label the potential transactions that the optimization engine 132 identifies as satisfying the optimization function. The optimization engine 132 may generate a list of the potential transactions. The optimization engine 132 may store the list of the potential transactions in memory or in a cache. In some embodiments, the optimization engine 132 may transmit, via the communicator 128, a record comprising the set of potential transactions to the client device 102 that transmitted the request.

The event detector 130 may comprise programmable instructions that, upon execution, cause the processor 124 to detect an event. The event may be any defined event, such as detecting a defined time or detecting a received input from a computing device, such as the client device 102. For example, the event detector 130 may be configured to detect a defined time at set intervals (e.g., for each increment). The event detector 130 may maintain an internal clock that keeps track of the current time. The event detector 130 may increment the internal clock over time. The event detector 130 may monitor the internal clock by comparing the current time of the clock to a defined time. The event detector 130 may detect an event upon determining the current time of the clock matches a defined time stored in the memory 126. In another example, the event detector 130 may detect an event upon receipt of an input. The transaction manager 104 may receive the input from the client device 102 in a request. In another example, the event detector 130 may detect an event upon receiving the initial request from the client device 102 (e.g., the optimization engine 132 may select a set of potential transactions for an account based on a request from a client device and the event detector 130 may detect an event based on the same request). The event detector 130 may detect any type of event.

The events may operate as interrupts that trigger the transaction manager 104 to execute the optimization engine 132 using a batch processing technique. For example, the optimization engine 132 may select a set of potential transactions that satisfy criteria input into the optimization function. The optimization engine 132 may store the selected set of potential transactions in the memory 126. The event detector 130 may detect an event. Responsive to detecting the event, the transaction manager 104 may iteratively execute the optimization engine 132 using the set of potential transactions as input and the same criteria as the criteria the optimization engine 132 used as constraints for the optimization function to select the set of potential transactions. The ranking engine 134 may rank each potential transaction of the set of potential transactions according to the iterative execution.

For each iterative execution of the optimization engine 132, the transaction manager 104 may remove a different potential transaction from the set of potential transactions. For example, upon the event detector 130 detecting an event, the transaction manager 104 may retrieve the set of potential transactions from memory. The transaction manager 104 may remove a potential transaction from the set of potential transactions. In some embodiments, the transaction manager 104 may remove the potential transaction from the set of potential transactions by setting the constraints (e.g., constraints in the criteria used to configure the optimization engine 132) for the potential transaction to be equal to the size of the current position for the potential transaction (e.g., set the upper bound and the lower bound for the potential transaction equal to the current position for the potential transaction). For instance, the transaction manager 104 may alter or adjust the criteria the transaction manager 104 retrieves from the criteria database 142 according to the modified bounds for the transaction. The transaction manager 104 may configure the optimization engine 132 according to the modified criteria. In some embodiments, the transaction manager 104 may remove the potential transaction by not including the potential transaction in the input to the optimization engine 132. In this way, the transaction manager 104 may prevent inclusion of the potential transaction from the set of potential transactions in the execution of the optimization engine 132.

The transaction manager 104 may execute the optimization engine 132 to identify a new set of potential transactions and/or a value for the removed transaction. The transaction manager 104 may do so using the same potential transactions and criteria as the potential transactions and criteria used to identify the initial set of potential transactions except for the removed potential transaction. The optimization engine 132 may output a value for the execution and/or a new set of potential transactions. In some embodiments, the transaction manager 104 may only input the set of potential transactions (e.g., with the potential transaction removed) into the optimization engine 132 and execute the optimization engine 132 to generate a value for the removed potential transaction. The transaction manager 104 may store the value in memory with an association with the potential transaction the transaction manager 104 removed from the set of potential transactions. The transaction manager 104 may then update the set of potential transactions by inserting the previously removed potential transaction back into the set of potential transactions and removing a different potential transaction from the set of potential transactions. The transaction manager 104 may remove the potential transaction in a similar manner to the manner described above (e.g., by updating the criteria used to configure the optimization engine 132 by setting the bounds for the potential transaction or by not including the potential transaction in the input into the optimization engine 132). The transaction manager 104 may execute the optimization engine 132 using the potential transactions from the transaction database 140 and with the potential transaction from the set of potential transactions removed. The optimization engine 132 may output a value for the execution. The transaction manager 104 may store the value in memory with an association with the potential transaction removed for the second iterative execution. The transaction manager 104 may iteratively execute the optimization engine 132 removing a different potential transaction from the set of potential transactions in this manner for each iterative execution until performing an iterative execution for each potential transaction of the set. Accordingly, the transaction manager 104 may maintain and store values for each potential transaction of the set of potential transactions.

The ranking engine 134 may comprise programmable instructions that, upon execution, cause the processor 124 to rank potential transactions of sets of potential transactions. The ranking engine 134 may rank potential transactions based on the values for the potential transactions the optimization outputs. For example, the ranking engine 134 may retrieve the output value the optimization engine 132 generated for the entire set of potential transactions (e.g., the set of potential transactions determined without any potential transactions removed). The ranking engine 134 may also retrieve the output values the optimization engine 132 generated for each potential transaction (e.g., the values the optimization engine 132 generated when the transaction manager 104 executed the optimization engine 132 for each potential transaction of the set of potential transactions except for the potential transaction). The ranking engine 134 may compare the output value for each potential transaction to the output value for the entire set of potential transactions to determine a difference (e.g., a positive difference if the output value for the individual potential transaction is lower than the output value for the entire set of potential transactions and a negative difference if the output value for individual potential transactions is higher than the output value for the entire set of potential transactions). The difference may be an effect of the removed potential transaction. The ranking engine 134 may compare the differences with each other. Based on the comparison, the ranking engine may rank the potential transactions in descending order in which the potential transactions that correspond to the highest positive differences correspond to higher rankings. The ranking engine 134 may assign (e.g., store) values indicating the rankings in memory with associations with the respectively ranked potential transactions.

For example, the optimization engine 132 and the ranking engine 134 may operate to rank potential transactions A, B, C, and D subsequent to the optimization engine 132 selecting potential transactions A, B, C, and D as optimizing a set of potential transactions according to a set of criteria. The optimization engine 132 may output a value for the set of potential transactions A, B, C, and D. Responsive to the event detector 130 detecting an event, the transaction manager 104 may iteratively execute the optimization engine 132 with the set of potential transactions A, B, C, and D, and, in some cases, the other potential transactions the transaction manager 104 initially retrieved from the transaction database 140 to identify the set of potential transactions A, B, C, and D. The transaction manager 104 may iteratively remove a different one of the potential transactions A, B, C, or D for each execution such that the transaction manager 104 executes the optimization engine 132 with other potential transactions for each execution. The optimization engine 132 may generate a value for the removed potential transaction with each iteration (e.g., generate a value for the potential transaction A upon removing the potential transaction A from the set and executing the optimization engine 132 to identify a new set of potential transactions that may include B, C, and D, etc., or may include new potential transactions). The ranking engine 134 may compare the values for the potential transactions A, B, C, and D with the value for the entire set of potential transactions to determine a difference for each of the potential transactions A, B, C, and D. The ranking engine 134 may then rank the potential transactions A, B, C, and D in descending or ascending order based on the differences with the highest positive difference being the highest ranked (e.g., ranked number one).

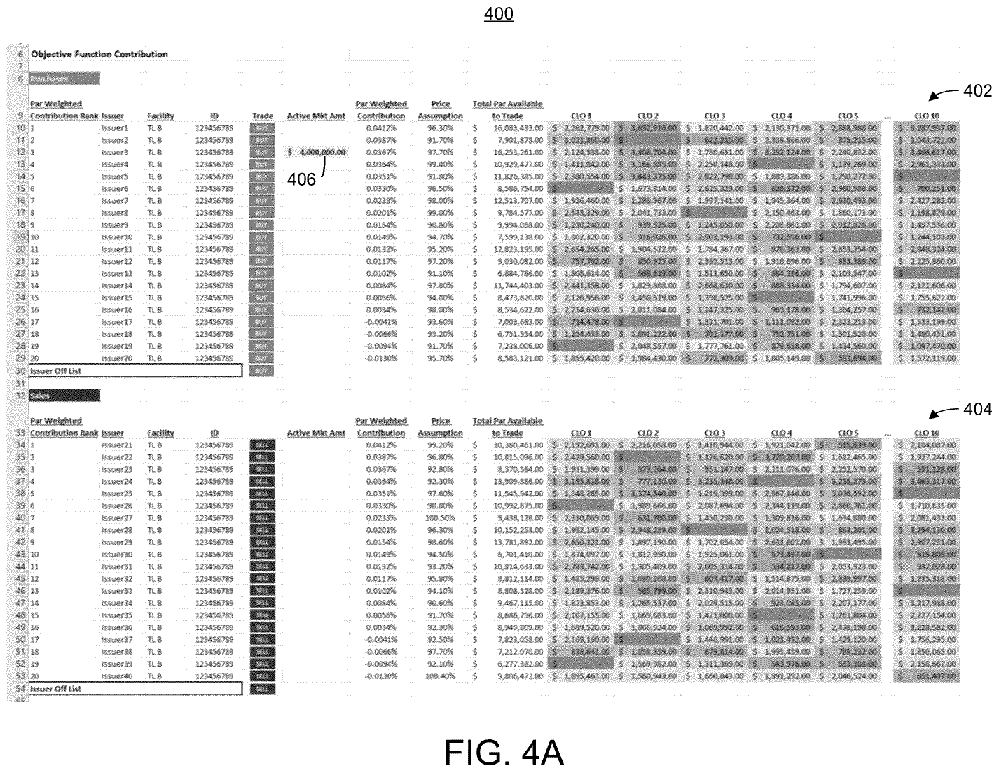

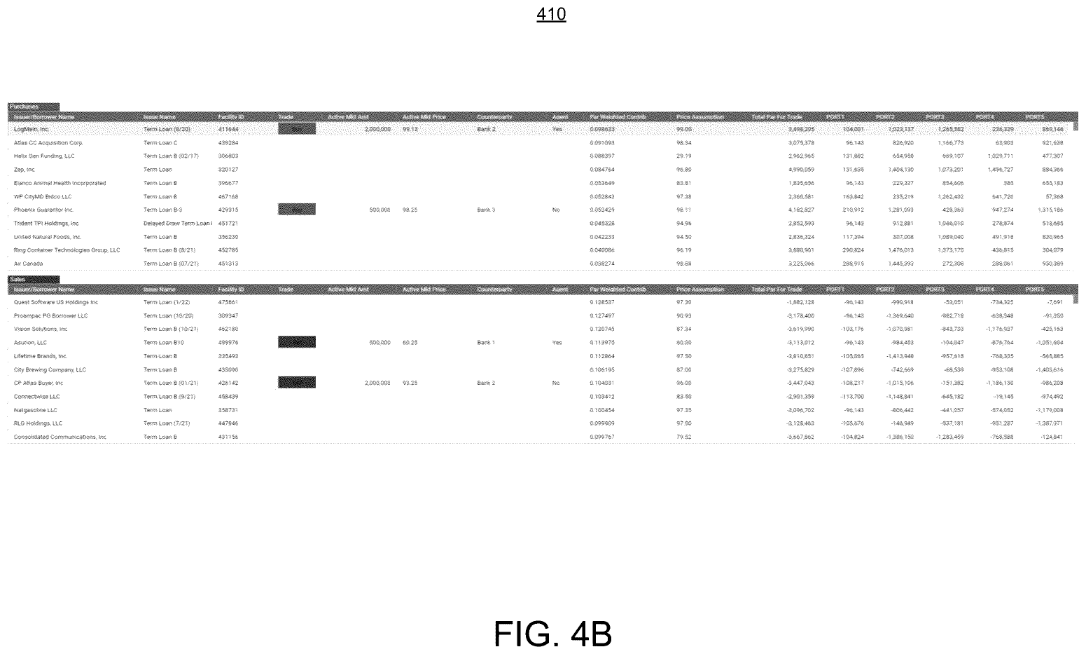

The record generator 138 may generate a record (e.g., a file, document, table, listing, message, notification, etc.). The record generator 138 may generate the record to include the ranking for each potential transaction of the set of potential transactions. For example, the record generator 138 may include an identification for each potential transaction of the set of potential transactions next to the ranking for the potential transaction. In some cases, the record generator 138 may include the calculated differences for the potential transactions. In one example, the record may be or include a spreadsheet or table, similar to the spreadsheets or tables illustrated in FIGS. 4A and 4B.

In some embodiments, the transaction manager 104 generates multiple ranked sets of potential transactions. For example, the transaction manager 104 may generate a ranked set of potential transactions for potential transactions of different types. The potential transactions may be stored in the transaction database 140 with identifications of different transaction types (e.g., buy or sell). The transaction manager 104 may retrieve the potential transactions of specific transaction types from the transaction database 140 based on the identifications. The transaction manager 104 may implement the systems and methods described herein to generate a ranked set of potential transactions for the transaction type. The transaction manager 104 may retrieve transactions that correspond to a different transaction type from the transaction database 140. The transaction manager 104 may implement the systems and methods described herein to generate a ranked set of potential transactions for the different transaction type. The transaction manager 104 may determine ranked lists for any number of transaction types. The transaction manager 104 may transmit the ranked sets for the different transaction types to the client device 102 in a record (e.g., the same record).

In some embodiments, instead of or in addition to using batch processing techniques to rank the set of potential transactions, the transaction manager 104 may use parallel processing techniques to rank the set of potential transactions. For example, the transaction manager 104 may transmit the potential transactions to the computing devices 108. In doing so, the transaction manager 104 may transmit one or more identifications of a different subset of potential transactions of the set of potential transactions to each of the computing devices 108 (e.g., transmit an identification of each potential transaction of a subset of potential transactions to a computing device).

The computing devices 108 may determine values for the potential transactions of the subsets of potential transactions for which the computing devices 108 respectfully received identifications. For example, each of the computing devices 108 may execute an optimization engine. The computing devices 108 may configure the optimization engines with the same criteria the transaction manager 104 used to configured the optimization engine 132 (e.g., the transaction manager 104 may transmit the criteria to the computing devices 108 and the computing devices 108 may configure the optimization engines using the same criteria as the optimization engine 132). A computing device 108 may remove a potential transaction of the subset of potential transactions for which the computing device 108 received identifications. The computing device 108 may execute the optimization engine the computing device 108 stores locally in memory using the potential transactions except for the removed potential transaction to determine a value for the removed potential transaction. The computing device 108 may iteratively execute the optimization engine, removing a different potential transaction from the subset of potential transactions for each execution to determine values for the respective removed potential transactions. The computing device 108 may transmit the values to the transaction manager 104 upon determining a value for each potential transaction. Each computing device 108 that receives an identification or identifications of a subset of potential transactions may determine values for potential transactions in this manner and transmit the values to the transaction manager 104. Accordingly, the computing devices 108 may operate in parallel to determine values for individual potential transactions, reducing the amount of time that is required for such processing.

The transaction manager 104 may receive the values from the computing devices 108. The transaction manager 104 may determine differences for and/or rank the potential transactions of the set of potential transactions in the manner described herein. In some embodiments, the transaction manager 104 may transmit the value for the entire set of potential transactions to the computing devices 108. In such embodiments, the computing devices 108 may determine differences between the value for the entire set of potential transactions and the values for the potential transactions locally. The computing devices 108 may transmit the determined differences to the transaction manager 104. The transaction manager 104 may use the determined differences to rank the potential transactions of the set of potential transactions. The transaction manager 104 may generate a record comprising the ranked set of potential transactions.

The communicator 128 may transmit the record to the client device 102. The communicator may transmit the record to the client device 102 in a user interface and/or as a data packet including the data of the record. The client device 102 may receive the record and/or the data of the data packet. The client device 102 may display the data of the record on a display. Accordingly, the transaction manager 104 may use the optimization engine 132 to not only select a set of potential transactions that satisfy criteria and that optimize a set of constraints, but provide a ranked list of potential transactions that the client device 102 can display on a user interface.

The communicator 128 may receive a selection of a subset (e.g., one or more) of the set of potential transactions from the client device 102. For example, subsequent to transmitting the record to the client device 102, the client device 102 may display the set of potential transactions on a user interface to a user of the client device 102. The user may use an input/output device to select one or more of the potential transactions from the set of the potential transactions. The user may then select a button at the user interface that causes the client device 102 to transmit a message to the transaction manager 104 with identifications and/or, in some cases, transaction attributes of the selected potential transactions. The transaction manager 104 may receive the message via the communicator 128.

Responsive to receiving the message containing the selected potential transactions, the transaction manager 104 may execute the optimization engine 132 using the selected potential transactions. The transaction manager 104 may execute the optimization engine 132 using the same criteria the transaction manager 104 used to generate the set of potential transactions. The optimization engine 132 may output a subset of the selected potential transactions that optimize the optimization function and/or that satisfy the criteria. The record generator 138 may generate a record containing identifications of the subset of the selected potential transactions. The communicator 128 may transmit the generated record to the client device 102 for display.

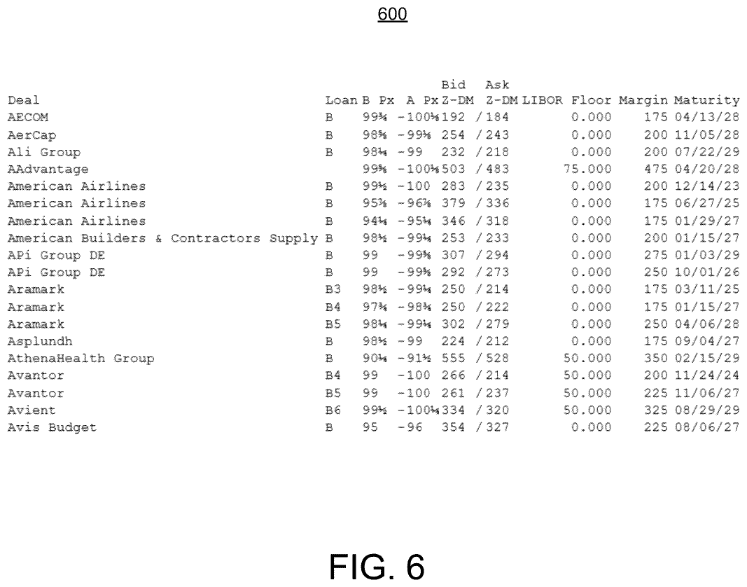

In some embodiments, the client device 102 may only select from matching transactions when selecting potential transactions for the transaction manager 104 to optimize using the optimization engine 132. For example, one or more computing devices (e.g., the computing device 110) may store available transactions in memory. The available transactions may be transactions that the owners of the one or more computing devices own or otherwise correspond to. The one or more computing devices may receive updates of available transactions responsive to receiving a user input. Each of the available transactions may include transaction attributes as described above. An example of a list of available transactions the computing device 110 may provide or transmit to the transaction manager 104 is illustrated as list of available transactions 600 in FIG. 6.

The parser 136 may comprise programmable instructions that, upon execution, cause the processor 124 to parse and match available transactions with potential transactions. The parser 136 may parse available transactions that the parser 136 receives from the one or more computing devices. In doing so, the parser 136 may extract transaction attributes from the available transactions. The parser 136 may compare the extracted transaction attributes of the available transactions with the transaction attributes of potential transactions of the set of potential transactions the communicator 128 transmitted to the client device 102. The parser 136 may identify a match between an available transaction and a potential transaction based on the comparison. Responsive to identifying a match, the communicator 128 may transmit a message to the client device 102 indicating the match (e.g., indicating the potential transaction that matched an available transaction). The client device 102 may receive the message and update the user interface to indicate the potential transaction that matches an available transaction. Accordingly, the client device 102 may update the user interface to indicate which potential transaction can be executed.

In some embodiments, to identify a match between an available transaction and a potential transaction, the parser 136 may identify a matching transaction identifier. For example, each potential transaction stored in the transaction database 140 may correspond to a unique transaction identifier from the other potential transactions. The available transactions of the one or more computing devices may correspond to a unique transaction identifier from the other available transactions. The parser 136 may compare the transaction identifiers of the available transactions with the transaction identifiers of the set of potential transactions. The parser 136 may determine a potential transaction matches an available transaction responsive to determining the transaction identifier for the potential transaction matches (e.g., is identical to) the transaction identifier for the available transaction.

In some embodiments, the parser 136 may identify a match between an available transaction and a potential transaction using machine learning techniques. For example, the parser 136 may insert transaction attributes for a potential transaction and transaction attributes for an available transaction into a machine learning model (e.g., a neural network, a support vector machine, a clustering model, a random forest, etc.). The machine learning model may be trained to output a likelihood of a match between a potential transaction and an available transaction based on transaction attributes of the two transactions. The parser 136 may execute the machine learning model using the transaction attributes of the potential transaction and the available transaction as input. The machine learning model may output a likelihood that the two transactions match based on the execution. The parser 136 may compare the likelihood to a threshold. Responsive to determining the likelihood exceeds the threshold, the parser 136 may determine the available transaction and the potential transaction match. Otherwise, the parser 136 may determine the available transaction and the potential transaction do not match. The parser 136 may similarly determine whether each variation of available transactions and potential transactions match using machine learning techniques.

In some embodiments, the transaction manager 104 may train the machine learning model. The transaction manager 104 may train the machine learning model using supervised, semi-supervised, or unsupervised techniques. For example, the transaction manager 104 may receive a training data set containing transaction attributes for pairs of available transactions and potential transactions. The transaction manager 104 may input the training data set into the machine learning model and execute the machine learning model. The machine learning model may output a likelihood that an available transaction matches a potential transaction for each pair of transactions of the training data set. The transaction manager 104 may determine a difference between the expected output (e.g., the ground truth) and the actual output and use back-propagation techniques according to the determined difference to update any weights and/or parameters of the machine learning model. The transaction manager 104 may similarly train the machine learning model for each pair of transactions. The transaction manager 104 may train the machine learning model until the machine learning model is accurate to a threshold (e.g., a predetermined threshold). Upon determining the machine learning model is accurate to the threshold, the transaction manager 104 may implement the machine learning model to determine matches between potential transactions and available transactions.

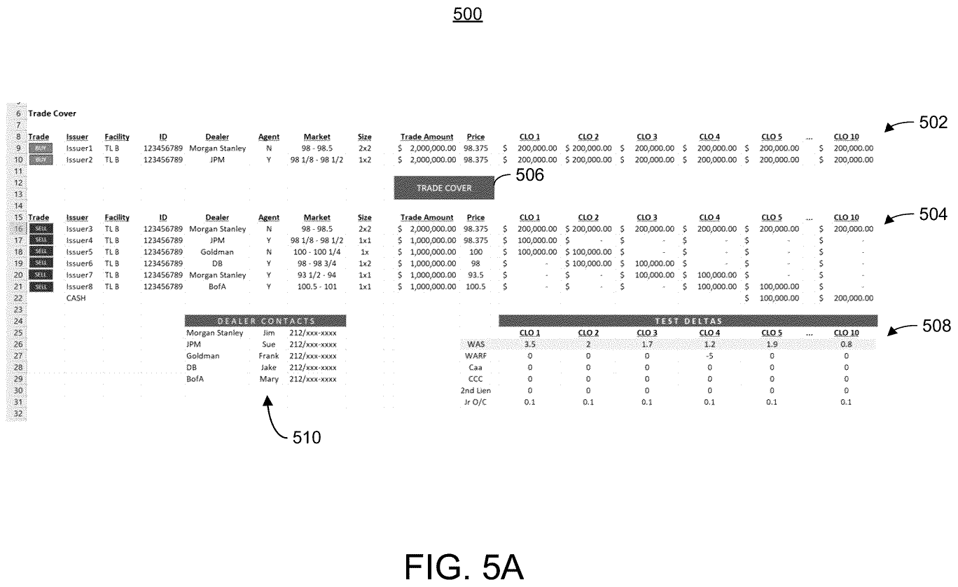

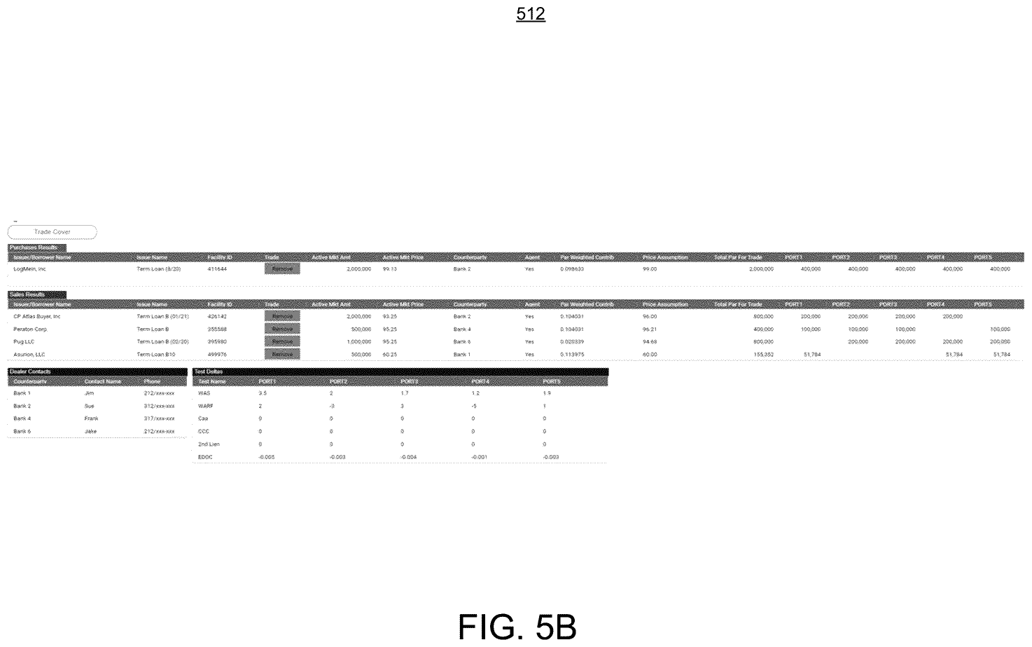

Subsequent to receiving an indication of the matching transaction or transactions, the client device 102 may display the indication on the user interface containing the ranked set of potential transactions. The client device 102 may do so by placing a selectable button next to each of the potential transactions the parser 136 identifies as matching an available transaction. A user accessing the client device 102 may view the selectable button or selectable buttons and select one or more of the selectable buttons using an input/output device (e.g., a mouse, touchpad, or keyboard). Responsive to selecting one of the one or more selectable buttons, the client device 102 may display another user interface (e.g., the user interface illustrated in FIG. 5) that includes data of the selected potential transaction or potential transactions.

From the user interface, the user may select a selectable button (e.g., a “trade cover” button). Selection of the selectable button may cause the client device 102 to transmit a message to the transaction manager 104 containing identifications of the selected matching potential transactions. The transaction manager 104 may receive the message and execute the optimization engine 132 using the selected matching potential transactions as input and configured with the same criteria as the criteria that caused the transaction manager 104 to generate the initial set of potential transactions. Upon execution, the optimization engine 132 may output a new set of potential transactions selected from the selected matching potential transactions responsive to the new set of potential transactions optimizing the optimization function of the optimization engine 132. The communicator 128 may generate a record containing a list of the new set of potential transactions. The communicator 128 may transmit the record to the client device 102.

In some embodiments, the transaction manager 104 may select a set of available transactions that optimize the optimization function of the optimization engine 132 including the matched or selected available transaction. For example, the transaction manager 104 may retrieve the available transactions from memory. In some embodiments, the transaction manager only retrieves available transactions of the opposite or a different transaction type than the transaction type of the matched or selected available transaction. The transaction manager 104 may input the retrieved available transactions into the optimization engine 132. The optimization engine 132 may be configured with the same criteria as the criteria that was used to select the set of potential transactions. The optimization engine 132 may freeze the selected matched available transaction such that the optimization engine 132 selects optimal available transactions assuming the matched available transaction is selected. The transaction manager 104 may execute the optimization engine 132. The optimization engine 132 may output a selected set of available transactions that optimize the optimization function and that includes the selected matched available transaction. The transaction manager 104 may transmit the selected set of available transactions to the client device 102 for display.

In some embodiments, the transaction manager 104 may iteratively execute the optimization engine 132 using different variations of the selected set of available transactions (and the matched available transaction or available transactions). The transaction manager 104 may input one or more of the selected set of available transactions into the optimization engine 132 and execute the optimization engine 132. The optimization engine 132 may output values for the individual transactions and/or the one or more of the selected set of available transactions. The transaction manager 104 may input different permutations of the selected set of available transactions into the optimization engine 132. The optimization engine 132 may output a value for each permutation as well as values for the individual available transactions for the permutation for each permutation. The transaction manager may transmit the output values to the client device 102 for display.

The client device 102 may execute the potential transactions identified in the record. For example, the client device 102 may receive the record from the communicator 128. The client device 102 may identify the potential transactions from the record. The client device 102 may identify the computing devices that are associated with the issuers or dealers of the transactions. In some cases, the client devices 102 may identify connections that the client device 102 had previously established (e.g., via a handshaking protocol using a syn packet) with the computing devices associated with such issuers or dealers. The client device 102 may transmit a message to the computing devices of the issuers or dealers to complete or perform one or more of the potential transactions identified in the record. In some cases, the client device 102 may display the record, receive a selection of one or more of the potential transactions identified in the record, and transmit messages to computing devices associated with issuers or dealers associated with the selected potential transactions.

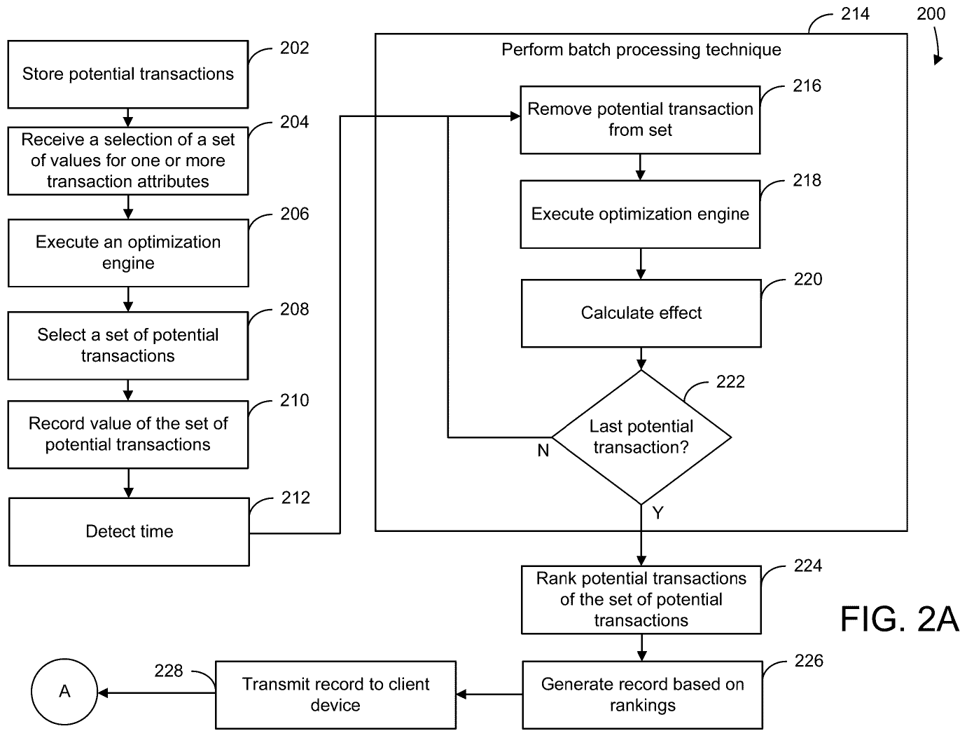

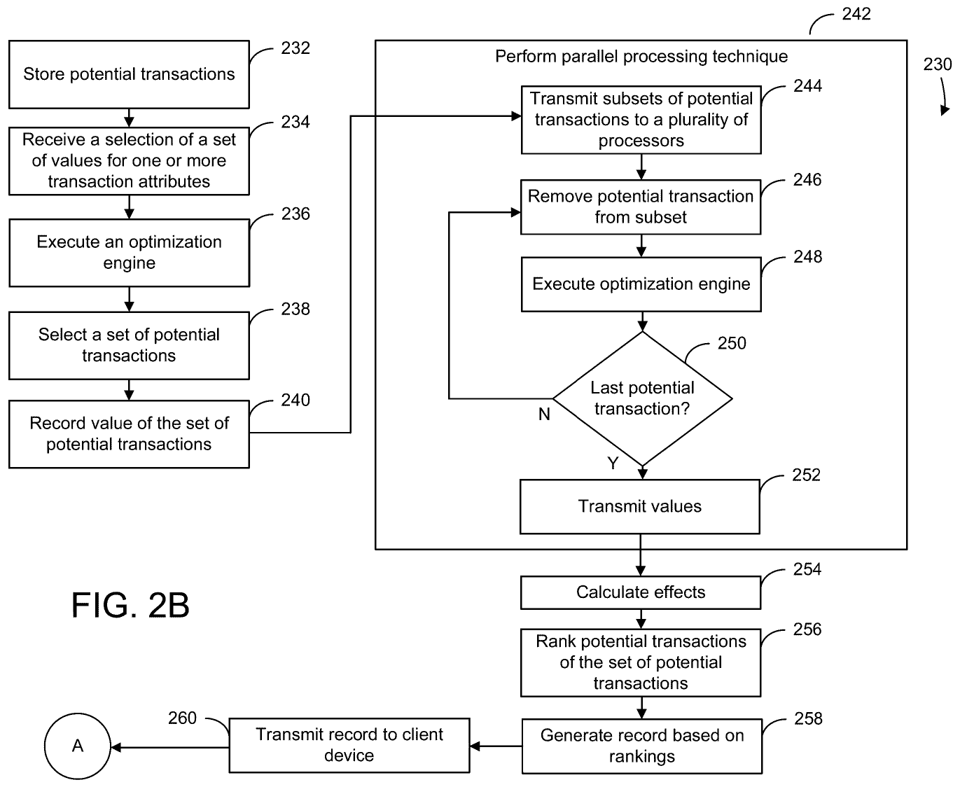

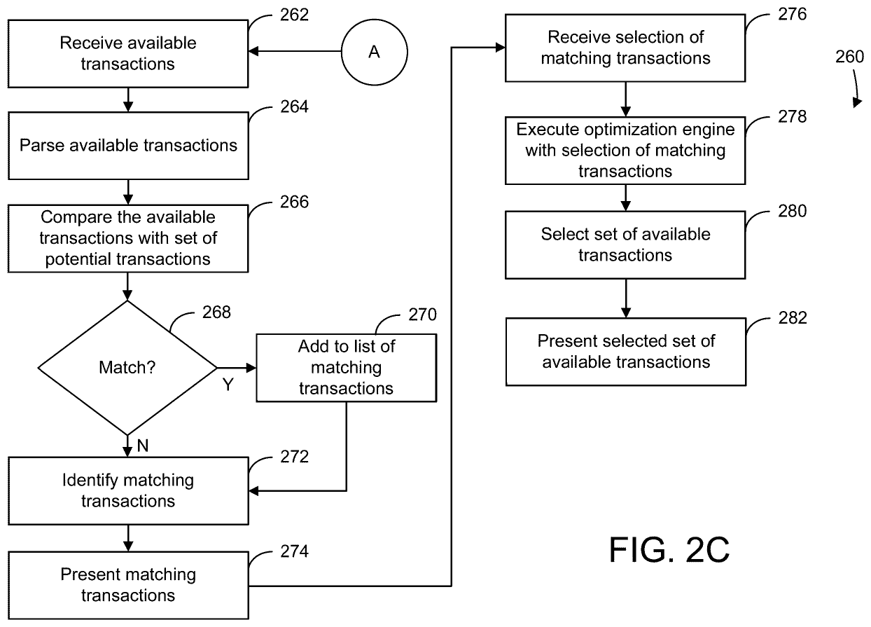

FIGS. 2A-2C are illustrations of an example method 200 for efficient transaction processing, in accordance with an implementation. The method 200 can be performed by a data processing system (e.g., a client device or the transaction manager 104, shown and described with reference to FIG. 1, a server system, etc.). The method 200 may include more or fewer operations and the operations may be performed in any order. Performance of the method 200 may enable the data processing system to efficiently use an optimization engine (e.g., using batch processing or parallel processing techniques) to select a set of potential transactions that optimally satisfy a set of criteria and to rank the selected set of potential transactions. The data processing system may provide the ranked set of potential transactions to a client device. A user accessing the client device may use the ranked set of potential transactions to determine which transactions to execute.

At operation 202, the data processing system stores potential transactions. Potential transactions may be or include transactions that can be performed for an account. Potential transactions may each include values for one or more transaction attributes. The potential transactions may correspond to different issuers and/or dealers. The data processing system may store the potential transactions in a database stored in memory.

At operation 204, the data processing system receives a selection of a set of values for one or more transaction attributes. For example, the data processing system may present a user interface of a platform at a client device. The user interface may include forms and/or selectable buttons for different transaction attributes. A user accessing the client device may view the forms and/or selectable buttons and select values (e.g., select values from the selectable buttons and/or input values into the forms) for the different transaction attributes via the user interface. The client device may receive the selected values from the user interface and transmit the selected values to the data processing system.

At operation 206, the data processing system executes an optimization engine. The data processing system may retrieve potential transactions the data processing system stores in the database. The data processing system may retrieve the optimization engine from memory. The data processing system may configure an optimization function of the optimization engine according to criteria (e.g., the values (e.g., the constraints) for the transaction attributes the data processing system received from the client device). The data processing system may input the transaction attributes of the potential transactions the data processing system retrieved from the database into the optimization engine. The data processing system may execute the optimization engine by maximizing the optimization function of the optimization engine according to the criteria the data processing system used to configure the optimization function.

At operation 208, the data processing system selects a set of potential transactions. The data processing system may select the set of potential transactions based on the set of potential transactions optimizing the optimization function of the optimization engine. The data processing system may select the set of potential transactions according to the execution of the optimization engine.

At operation 210, the data processing system records a value of the set of potential transactions. The value may be a value the optimization engine generated upon execution when generating the set of potential transactions. The data processing system may record the value by writing the value in memory. The data processing system may store an association between the set of potential transactions (e.g., an identification of the set of potential transactions) and the value in memory for later retrieval.

At operation 212, the data processing system detects a time. The data processing system may maintain an internal clock. The data processing system may increment the internal clock and compare the incremented time to a defined time in memory. The data processing system may repeatedly do so for each increment (e.g., each second or minute) until identifying a time on the internal clock that matches the defined time in memory. In some embodiments, instead of detecting a time, the data processing system may detect another event, such as a user input.

At operation 214, the data processing system may perform a batch processing technique. The data processing system may perform the batch processing technique in response to detecting a time or another event. The data processing system may perform the batch processing technique to calculate effects of individual potential transactions on the value for the set of potential transactions (e.g., a value for the removed potential transaction).

For example, at operation 216, the data processing system removes a potential transaction from the set of potential transactions. The data processing system may identify a potential transaction (e.g., a first potential transaction or any other potential transaction) from the set of potential transactions. The data processing system may remove the potential transaction from the set of potential transactions (e.g., the data processing system may alter or adjust the criteria the data processing system uses to configure the optimization engine to prevent the potential transaction from the set of potential transactions from being selected in a new set of potential transactions output by the optimization engine).

At operation 218, the data processing system executes the optimization engine. The data processing system may execute the optimization engine using the potential transactions (e.g., the same potential transactions from which the optimization engine identified the set of potential transaction or only the set of potential transactions) except for the removed potential transaction. The optimization engine may be configured according to the same criteria as the criteria the data processing system used to configure the optimization engine to select the set of potential transactions except, in some embodiments, for any adjustments to the criteria to remove the potential transaction from consideration for being selected in a new set of potential transactions. The data processing system may execute the optimization engine. The optimization engine may output a value and/or a new set of potential transactions. The value may be a value for the removed potential transaction.

At operation 220, the data processing system calculates an effect. The effect may be an impact of the removed potential transaction on the value of the set of potential transactions. The data processing system may retrieve the value for the entire set of potential transactions. The data processing system may compare or subtract the value for the potential transaction from the value for the entire set of potential transactions. The result of the subtraction or the comparison may be the effect of the potential transaction.

At operation 222, the data processing system determines whether the removed potential transaction was the last transaction that had not yet been removed from the set of potential transactions. For example, for each potential transaction the data processing system removes from the set of potential transactions, the data processing system may label or flag the potential transaction as having been removed from the set of potential transactions. Upon calculating the effect for the removed potential transaction, the data processing system may insert the potential transaction back into the set of potential transactions. The data processing system may determine whether the data processing system has determined an effect for each potential transaction of the set of potential transactions by querying the set of potential transactions for a potential transaction that has not yet been labeled or flagged or for which the data processing system has not yet calculated an effect. Responsive to identifying a potential transaction for which the data processing system has not yet determined an effect, the data processing system may remove the identified transaction from the set of potential transactions at operation 216 and repeat the operations 218-222. The data processing system may repeat the operations 216-222 until determining the data processing system has determined an effect for each potential transaction of the set of potential transactions.

At operation 224, the data processing system ranks the potential transactions of the set of potential transactions. The data processing system may rank the potential transactions according to the effects the data processing system may determine for the potential transactions. For example, the data processing system may compare the effects for the potential transactions. The data processing system may determine a ranked order (e.g., a ranked descending or ascending order) for the potential transactions based on the effects of the potential transactions. The data processing system may rank transactions higher the higher the positive difference and lower the negative difference. The data processing system may assign rankings to each of the potential transactions by storing associations between the rankings and the potential transactions in memory.

At operation 226, the data processing system generates a record. The data processing system may generate the record based on the rankings. For example, the data processing system may include identifications of the potential transactions in the set of potential transactions and rankings for the same potential transactions in the record. The data processing system may include data for the individual potential transactions in separate rows displayed on the client device (e.g., displayed in a table or in a spreadsheet). At operation 228, the data processing system transmits the record to the client device (e.g., the client device that provided the selection of the set of values to the data processing system).

In some embodiments, instead of or in addition to using batch processing techniques, the data processing system may implement parallel processing techniques to determine rankings for potential transactions of sets of potential transactions. For example, at operation 232, the data processing system stores potential transactions. At operation 234, the data processing system receives a selection of a set of values for one or more transaction attributes. At operation 236, the data processing system executes an optimization engine (e.g., the optimization engine described with reference to the operation 206). At operation 238, the data processing system selects a set of potential transactions. At operation 240, the data processing system records a value of the set of potential transactions. The data processing system may perform the operations 232-240 similar to how the data processing system performs the operations 202-212.

At operation 242, the data processing system performs parallel processing techniques. The data processing system may perform the parallel processing technique subsequent to selecting the set of potential transactions. The data processing system may perform the parallel processing technique to calculate effects of individual potential transactions on the value for the set of potential transactions.

For example, at operation 244, the data processing system may transmit subsets of potential transactions to a plurality of processors. The data processing system may transmit the potential transactions to each of the plurality of processors. The data processing system may transmit identifications (e.g., an identification of each potential transaction of a subset of potential transactions) of a different subset of potential transactions of the set of potential transactions to each of the plurality of processors. For instance, the data processing system may partition or segment the set of potential transactions into one or more groups of potential transactions. The data processing system may transmit identifications of one of the groups of the potential transactions (e.g., an identification of the group and/or identifications of each potential transaction of the group) to each processor.

At operation 246, each processor of the plurality of processors may remove a potential transaction from the potential transactions. The processor may remove a potential transaction that the data processing system identified as being a part of a subset of potential transactions. At operation 248, the processor executes an optimization engine that is configured similar to or the same as the optimization engine executed by the data processing system. The processor may execute the optimization engine using the potential transactions except for the removed potential transaction. The optimization engine may output a value for the potential transactions except for the removed potential transaction. The processor may store an association between the removed potential transaction and the value in memory.

At operation 250, the processor determines whether the removed potential transaction was the last transaction that had not yet been removed from the set of potential transactions of the subset of potential transactions. For example, for each potential transaction the processor removes from the potential transactions, the data processing system may label or flag the potential transaction as having been removed from the set of potential transactions. Upon executing the optimization engine with the potential transactions except for the removed potential transaction, the data processing system may insert the removed potential transaction back into the potential transactions. The processor may determine whether the processor has determined a value for each potential transaction of the subset of potential transactions by querying the potential transactions for a potential transaction of the subset of potential transactions that has not yet been labeled or flagged or for which the processor has not yet determined a value. Responsive to identifying a potential transaction for which the data processing system has not yet determined an effect, the processor may remove the identified potential transaction from the set of potential transactions at operation 246 and repeat operations 248-250. The processor may repeat operations 246-250 until determining the processor has determined a value for each potential transaction of the subset of potential transactions. At operation 252, the processor may transmit the values for the subset of potential transactions to the data processing system. Each processor of the plurality of processors may similarly determine values for a subset of potential transactions of the set of potential transactions that the data processing system identified in a message. By using parallel processing techniques in this way, the processors may quickly determine values for individual potential transactions instead of a single processor that determines the values for potential transactions one at a time in sequence, which can substantially increase the speed of the processing.

At operation 254, the data processing system calculates effects. An effect may be an impact of a removed potential transaction on the value of the set of potential transactions. The data processing system may retrieve the value for the entire set of potential transactions. The data processing system may receive the values for the individual potential transactions from the plurality of processors. The data processing system may compare or subtract each value for each potential transaction from the value for the entire set of potential transactions. The result of the subtraction or the comparison may be the effect of the removed potential transaction. The data processing system may similarly calculate such effects for each potential transaction of the set of potential transactions.

At operation 256, the data processing system ranks the potential transactions of the set of potential transactions. At operation 258, the data processing system generates a record based on the rankings. At operation 260, the data processing system transmits a record to the client device. The data processing system may perform operations 254-260 similar to how the data processing system performed the operations 224-228.

The data processing system may facilitate execution of the potential transactions. The data processing system may facilitate execution of the potential transactions subsequent to performing the operations 202-228 or operations 230-260. For example, at operation 262, the data processing system receives available transactions (e.g., a set of available transactions). The data processing system may receive the available transactions from one or more computing devices. Available transactions may be transactions that the owners of the one or more computing devices own or otherwise correspond to (e.g., and that can be executed). The available transaction may each include one or more transaction attributes.

At operation 264, the data processing system parses the available transactions. The data processing system may parse the available transactions by identifying or otherwise extracting values of attribute-value pairs of the available transactions. The data processing system may retrieve the values of the attribute-value pairs from the available transactions responsive to identifying or extracting the values of the attribute-value pairs.

At operation 266, the data processing system compares the available transactions with the set of potential transactions (e.g., the ranked set of potential transactions). The data processing system may compare the values of the available transactions with corresponding values (e.g., values of the same types of attribute-value pairs) of the potential transactions. The data processing system may determine whether individual potential transactions match individual available transactions based on matches between the values of the two types of transactions satisfying a criterion (e.g., a match of a defined type or defined types of attribute-value pairs). In one example, the data processing system may determine a potential transaction matches an available transaction responsive to determine a match between a transaction identifier for the potential transaction and a transaction identifier for the available transaction.

In some embodiments, the data processing system compares potential transactions with available transactions by inputting the values for a potential transaction and an available transaction into a machine learning model. The data processing system may execute the machine learning model to obtain an output likelihood of whether the potential transaction and available transaction are a match. The data processing system may compare the output likelihood to a threshold. Responsive to determining the likelihood does not exceed the threshold, the data processing system may determine the potential transaction and available transaction are a match. Otherwise, the data processing system may determine the potential transaction and the available transaction are not a match. The data processing system may similarly determine matches between each permutation of potential transactions of the set of potential transactions and available transactions.

For each match the data processing system determines, at operation 270, the data processing system adds the matching transaction to a list of matching transactions. The list of matching transactions may be a data structure that includes transaction attributes of different available transactions or potential transactions that matched a transaction of the other type. For example, the data processing system may identify an available transaction that matches a potential transaction. The data processing system may store the attributes of the available transaction or the potential transaction in the list of matching transactions. The data processing system may similarly add any number of matching transactions to the list of matching transactions.

In some embodiments, the list of matching transactions may update based on the time when the potential transaction was received at operation 262 relative to the current time. For example, a potential transaction expiration time could be set in the client device (e.g., the client device that input the values for transaction attributes at operation 204 or 234) and the potential transaction removed from the list of matching transactions should the difference between the current time and the time when the potential transaction was received at operation 262 exceeds the potential transaction expiration time.

At operation 272, the data processing system identifies matching transactions. The data processing system may identify matching transactions from the list of matching transactions. At operation 274, the data processing system presents the matching transactions. The data processing system presents the matching transactions at the client device (e.g., the client device that input the values for transaction attributes at operation 204 or 234). The data processing system may transmit the list of matching transactions to the client device and/or a user interface containing the list of matching transactions. The client device may display the list and/or the user interface upon receipt of the list and/or user interface.

At operation 276, the data processing system receives a selection of matching transactions (e.g., available transactions that matched one or more of the set of potential transactions). The data processing system may receive the selection of matching transactions from the client device. For example, the data processing system may update the user interface presented at the client device to include one or more selectable buttons that correspond to potential transactions from the set of potential transactions for which the data processing system identified a matching available transaction. A user accessing the client device may select one or more of the potential transactions that match an available transaction via such selectable buttons. In response to selecting the selectable button, the client device may transmit identifications of the available transactions that match a potential transaction that the user selected to the data processing system.

At operation 278, the data processing system executes the optimization engine. The data processing system may execute the optimization engine with the selection of matching transactions as input. Additionally, the data processing system may retrieve the other available transactions the data processing system received and input the other available transactions into the optimization engine. The data processing system may execute the optimization engine such that the optimization function of the optimization engine is configured with the same criteria as the criteria the data processing system used to configure the optimization engine to select the set of potential transactions. In some embodiments, the data processing system may execute the optimization engine freezing the selection of matching transactions. The data processing system may do so such that the optimization engine selects a set of available transactions assuming the selection of matched transactions will be included in an optimal set of available transactions (e.g., by adjusting the criteria used to configure the optimization engine to ensure the optimization engine selects the selected matching transactions, such as by setting the upper and/or lower bounds for the selected matching transactions in the criteria to ensure the selected available transactions are selected).

At operation 280, the data processing system selects a set of available transactions. The data processing system may select the set of available transactions based on the set of available transactions optimizing the optimization function of the optimization engine. The data processing system may select the set of available transactions according to the execution of the optimization engine.

At operation 282, the data processing system presents the selected set of available transactions. The data processing system may present the selected set of available transactions at the client device. For example, the data processing system may transmit the selected set of available transactions (e.g., identifications of the selected set of available transactions) and/or a user interface that includes the selected set of available transactions to the client device. The client device may receive the selected set of available transactions and the selected set of available transactions on a user interface.

The user accessing the client device may select one or more of the selected set of available transactions from the user interface. In response to the selection, the client device may communicate with the one or more computing devices that transmitted the available transactions of the selected set of available transactions to the data processing system. The client device may communicate with the one or more computing devices to facilitate the selected set of available transactions. Accordingly, the client device may use the platform provided by the data processing system to perform or execute transactions.

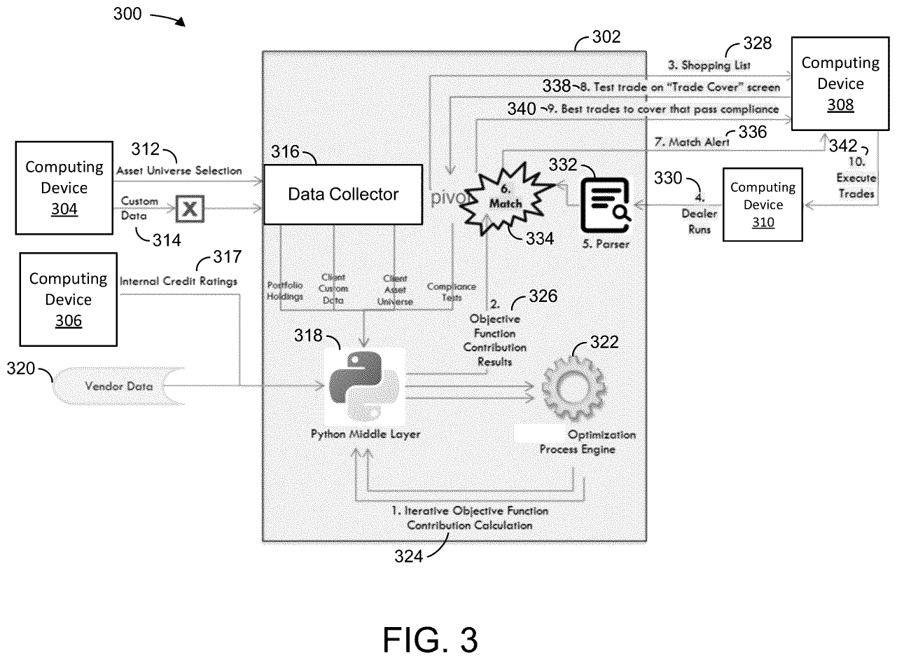

FIG. 3 is an illustration of an example sequence 300 for efficient transaction processing, in accordance with an implementation. The sequence 300 can be performed by a data processing system 302, a computing device 304, a computing device 306, a computing device 308, and a computing device 310. The data processing system 302 and/or the computing devices 304-310 may each be or include a client device, the transaction manager 104, shown and described with reference to FIG. 1, a server system, etc. The sequence 300 may include more or fewer operations and the operations may be performed in any order. Performance of the sequence 300 may enable the data processing system to efficiently and quickly determine rankings and identifications of potential transactions.

In the sequence 300, the computing device 304 may transmit identifications of data 312 and data 314 to a data collector 316. The data 306 may include current transactions that different individuals and/or group entities own (e.g., transactions that are stored in accounts in the transaction database 140, shown and described with reference to FIG. 1) and/or potential transactions that the data processing system can use to select and rank a set of potential transactions. The data 314 can include one or more constraints (e.g., values for types of attributes, such as a percentage of a transaction category or characteristic (e.g., MCC code) that can be included in a set of potential transactions).

The data collector 316 may be a component of the data processing system 302. The data collector 316 may transmit data the data collector 316 receives from the computing device 304 to a Python middle layer 318. The data collector 316 may transmit the data to the Python middle layer 318. The computing device 306 may transmit data 317 to the Python middle layer 318.

The Python middle layer 318 may be a component of the data processing system 302. The Python middle layer 318 may receive the data from the data collector 316 and the computing device 306. The Python middle layer 318 may also receive data 320 from other computing devices that may include values for different attributes. The Python middle layer may collect such data and configure an optimization process engine 322 with the data as criteria (e.g., constraints) for an optimization function executed by the optimization process engine 322.

At operation 324, the optimization process engine 322 may iteratively execute an objective function (e.g., an optimization function) with the data from the Python middle layer 318 operating as criteria (e.g., constraints) of the objective function. The optimization process engine 322 may iteratively execute to identify a set of potential transactions that optimally satisfy the objective function and determine rankings for each potential transaction in the set. At operation 326, the Python middle layer 318 may transmit a ranked set of potential transactions to the computing device 308 in a ranked list 328 (e.g., a shopping list). The Python middle layer 318 may transmit the ranked set of potential transactions in a user interface. At operation 330, the computing device 310 may transmit a set of available transactions to the data processing system 302. A parser 332 of the data processing system 302 may parse the values of the transaction attributes of the available transactions. The parser 332 may also parse the values of the potential transactions of the set of potential transactions generated by the optimization process engine 322. The parser 332 may compare the extracted values of the available transactions with the potential transactions. The parser 332 may identify a match between a potential transaction and an available transaction at operation 334.

At operation 336, subsequent to identifying the match, the data processing system 302 may transmit a match alert to the computing device 308. The match alert may indicate or identify the match between the available transaction and the potential transaction. The computing device 308 may receive the match alert and update a user interface to indicate the match. A user accessing the computing device 308 may view the match alert. At operation 338, the user may select a selectable button (e.g., a “test trade” selectable button) that may appear with the match alert. The computing device 308 may transmit an indication of the selection to the data processing system. Upon receiving the indication, the data processing system 302 may retrieve available transactions provided by the computing device 310 from memory. The data processing system 302 may input the available transactions with the matched transaction (e.g., the available transaction or the potential transaction of the matched transaction) into the optimization process engine 322. The data processing system 302 may execute the optimization process engine 322 freezing the matched transaction such that the optimization process engine 322 selects a set of available transactions assuming the matched transaction is included in the set. The optimization process engine 322 may output a set of available transactions including the matched transaction to the Python middle layer. The Python middle layer may transmit the set of available transactions to the computing device 308 at operation 340. The computing device 308 may present the set of available transactions at a user interface. At operation 342, a user accessing the computing device 308 may select an option to execute one or more of the available transactions presented on the user interfaces.

FIGS. 4A and 4B are illustrations of example user interfaces 400 and 410 for selecting matching transactions, in accordance with an implementation. A data processing system (e.g., a client device or the transaction manager 104, shown and described with reference to FIG. 1, a server system, etc.) may generate and transmit the user interface 400 to a computing device being accessed by a user. The data processing system may generate the user interface 400 responsive to selecting a set of potential transactions that optimize an optimization function of an optimization engine. For example, in selecting the set of potential transactions, the data processing system may generate a first set of potential transactions 402 and a second set of potential transactions 404 (together, the sets 402 and 404). The data processing system may assign rankings to each of the sets 402 and 404. The data processing system may display the two ranked sets 402 and 404 on the user interface 400.

In some embodiments, the data processing system may execute the optimization engine using different permutations of one or more of the set of potential transactions. In such instances, the optimization may output values for the individual potential transactions for each execution. The data processing system may display the values for each execution in a different column and in the rows that correspond to the respective potential transactions.

In some cases, the data processing system may determine a match for a potential transaction of one of the sets 402 or 404 with an available transaction. In such cases, the data processing system may identify a value from the available transaction that matched with the potential transaction. The data processing system may update the user interface 400 to include the identified value from the available transaction. For example, the data processing system may identify a match for the potential transaction ranked third in the set 402. The data processing system may retrieve a value 406 from the available transaction that matched the potential transaction and update the user interface 400 to include the value 406. In some cases, upon identifying the match and updating the user interface 400, the data processing system may also update the user interface 400 to include a selectable button that a user may select. Selecting the selectable button may cause the data processing system to generate and present a user interface 500, shown and described with reference to FIG. 5, at the computing device. The data processing system may similarly generate and operate according to inputs at the user interface 410.

FIGS. 5A and 5B are illustrations of example user interfaces 500 and 512 for identifying transactions, in accordance with an implementation. A data processing system (e.g., a client device or the transaction manager 104, shown and described with reference to FIG. 1, a server system, etc.) may generate and transmit the user interface 500 to a computing device being accessed by a user. The data processing system may generate the user interface 500 responsive to receiving a selection of a selectable button for a matched potential transaction or multiple matched potential transactions. For example, after identifying a match and receiving a selection of a selectable button, the data processing system may retrieve currently available transactions and present the currently available transactions on the user interface 500. The data processing system may include the retrieved currently available transactions with the matched transaction on the user interface 500. In some cases, the data processing system may retrieve the available transactions and execute an optimization engine (e.g., the optimization as described herein) using the matched transaction or transactions and different permutations of the available transactions as input. The data processing system may execute the optimization engine for each permutation, in some cases holding the matched available transactions constant while selecting different permutations of the available transactions to use as input with the matched transaction or matched transactions. The optimization engine may output a value for each execution, in some cases outputting a value for each available transaction of the execution. The data processing system may include the outputs for the available transactions in the entries 502 and in the entries 504. In some cases, the data processing system may execute the optimization engine in response to a selection of an executable button 506.

The data processing system may also include a widget 508 and a widget 510 in the user interface 500. The widget 508 may include differences in values (e.g., differences in values compared to a base value, an average value across permutations, or a previously determined value) for different types of transactions of the analyzed transactions identified in the entries 502 and 504. The widget 510 may include contact information for different individuals associated with the transactions. The data processing system may similarly generate and operate according to inputs at the user interface 512.

At least one aspect of a technical solution to the aforementioned problem is directed to a method. The method may include storing, by a processor, a plurality of potential transactions, each potential transaction including one or more transaction attributes; receiving, by the processor, a selection of a set of values for the one or more transaction attributes; selecting, by the processor using an optimization engine, a set of potential transactions from the plurality of potential transactions according to an optimization function and the selection of the set of values; detecting, by the processor, a defined time on an internal clock maintained by the processor; responsive to detecting the defined time, iteratively executing, by the processor, the optimization engine removing a different potential transaction from the set of potential transactions for each execution; and generating, by the processor, a record including a ranking for each potential transaction of the set of potential transactions according to the iterative executions.

In some embodiments, iteratively executing the optimization engine includes, for each execution inserting, by the processor, the set of potential transactions into the optimization engine except for one potential transaction of the set of potential transactions; executing, by the processor, the optimization engine with the set of potential transactions except for the one potential transaction; and determining, by the processor from the optimization engine based on the executing, an effect of the one potential transaction. In some embodiments, the determining the effect of the one potential transaction includes by determining a difference between an output of the optimization engine with the set of potential transactions except for the one potential transaction as input and an output of the optimization engine with each potential transaction of the set of potential transactions as input.

In some embodiments, the method further includes transmitting, by the processor, the record including the rankings for the set of potential transactions to a client device, wherein the client device displays the rankings for the set of potential transactions on a user interface. In some embodiments, the method further includes receiving, by the processor, a selection of a subset of the set of potential transactions from the client device; and responsive to receiving the selection of the subset of the set of potential transactions, executing, by the processor, the optimization engine based on the subset of potential transactions.

In some embodiments, the method further includes receiving, by the processor from one or more computing devices, a set of available transactions; extracting, by the processor, one or more attributes of the set of available transactions; comparing, by the processor, the one or more attributes of the set of available transactions with one or more attributes of the set of potential transactions; and identifying, by the processor, one or more matching transactions between the set of available transactions and the set of potential transactions based on the comparison. In some embodiments, the subset of potential transactions only includes potential transactions from the one or more matching transactions.

In some embodiments, comparing the one or more attributes of the set of available transactions with the one or more attributes of the set of potential transactions includes executing, by the processor, a machine learning model using the one or more attributes of the set of available transactions and the one or more attributes of the set of potential transactions as input, the machine learning model trained to output a likelihood of a match between a potential transaction and an available transaction; and determining, by the processor, the one or more matching transactions based on an output of the machine learning model based on the executing the machine learning model.

In some embodiments, determining the one or more matching transactions includes comparing, by the processor, a likelihood of a match between a potential transaction and an available transaction to a threshold; and determining, by the processor, a matching transaction between the potential transaction and the available transaction responsive to determining the likelihood exceeding the threshold. In some embodiments, comparing the one or more attributes of the set of available transactions with the one or more attributes of the set of potential transactions includes comparing, by the processor, a transaction identifier of an available transaction with a transaction identifier of a potential transaction; and determining, by the processor, a matching transaction between the available transaction and the potential transaction based on the comparing the transaction identifier of the available transaction with the transaction identifier of the potential transaction.

In some embodiments, determining the matching transaction between the available transaction and the potential transaction includes determining, by the processor, the transaction identifier of the available transaction is identical to the transaction identifier of the potential transaction. The method of claim 4, wherein the client device displays the rankings for the set of potential transactions in a spreadsheet or a table. In some embodiments, the method further includes transmitting, by the processor, a second record including a subset of the set of available transactions according to the executing the optimization engine using the one or more available transactions as input. In some embodiments, the client device displays the rankings for the set of potential transactions in separate rows, organized as a table or a spreadsheet.

At least one aspect of a technical solution to the aforementioned problem is directed to a system. The system may include one or more processors configured by machine-readable instructions to store a plurality of potential transactions, each potential transaction including one or more transaction attributes; receive a selection of a set of values for the one or more transaction attributes; select, using an optimization engine, a set of potential transactions from the plurality of potential transactions according to an optimization function and the selection of the set of values; detect a defined time on an internal clock maintained by the one or more processors; responsive to detecting the defined time, iteratively execute the optimization engine removing a different potential transaction from the set of potential transactions for each execution; and generate a record including a ranking for each potential transaction of the set of potential transactions according to the iterative executions.

In some embodiments, the one or more processors are configured to iteratively execute the optimization engine by, for each execution inserting the set of potential transactions into the optimization engine except for one potential transaction of the set of potential transactions; executing the optimization engine with the set of potential transactions except for the one potential transaction; and receiving, from the optimization engine based on the executing, an effect of the one potential transaction. In some embodiments, the one or more processors are configured to transmit the record including the rankings for the set of potential transactions to a client device, wherein the client device displays the rankings for the set of potential transactions on a user interface. In some embodiments, the one or more processors are configured to receive a selection of a subset of the set of potential transactions from the client device; and responsive to receiving the selection of the subset of the set of potential transactions, execute the optimization engine based on the subset of potential transactions.

At least one aspect of a technical solution to the aforementioned problem is directed to a method. The method may include storing, by a processor, a plurality of potential transactions, each potential transaction including one or more transaction attributes; receiving, by the processor, a selection of a set of values for the one or more transaction attributes; selecting, by the processor using a first optimization engine, a set of potential transactions from the plurality of potential transactions according to an objective function and the selection of the set of values; transmitting, by the processor to a plurality of processors, the set of potential transactions, the processor transmitting one or more identifications of a different subset of potential transactions of the set of potential transactions to each of the plurality of processors; executing, by each of the plurality of processors, a second optimization engine corresponding to the first optimization engine removing a potential transaction of the subset of potential transactions received by the processor for each iterative execution; and generating, by the processor, a record including a ranking for each potential transaction of the set of potential transactions according to the iterative executions of each of the plurality of processors.

In some embodiments, the method includes receiving, by the processor, an effect of a potential transaction from each of the plurality of processors; and ranking, by the processor, the set of potential transactions according to the effect of each of the set of potential transactions. In some embodiments, the method includes transmitting, by the processor, the record including the rankings for the set of potential transactions to a client device, wherein the client device displays the rankings for the set of potential transactions on a user interface.

These and other aspects and implementations are discussed in detail herein. The foregoing information and the detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “computing device” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the client device 102 or the transaction manager 104) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

The phraseology and terminology used herein is for the purpose of description and should not be regarded as limiting. Any references to implementations or elements or acts of the systems and methods herein referred to in the singular may also embrace implementations including a plurality of these elements, and any references in plural to any implementation or element or act herein may also embrace implementations including only a single element. Any implementation disclosed herein may be combined with any other implementation or embodiment.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B,’” can include only ‘A’, only ‘B’, as well as both ‘A’ and ‘B’. Such references used in conjunction with “comprising,” “including,” or other open terminology can include additional items.

The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method, comprising:
storing, by a processor, a plurality of potential transactions, each potential transaction comprising one or more transaction attributes;
receiving, by the processor, a selection of a set of values for the one or more transaction attributes;
selecting, by the processor using an optimization engine, a set of potential transactions from the plurality of potential transactions according to an optimization function and the selection of the set of values;
detecting, by the processor, a defined time on an internal clock maintained by the processor;
responsive to detecting the defined time, iteratively executing, by the processor, the optimization engine removing a different potential transaction from the set of potential transactions for each execution; and
generating, by the processor, a record comprising a ranking for each potential transaction of the set of potential transactions according to the iterative executions.

2. The method of claim 1, wherein iteratively executing the optimization engine comprises, for each execution:
inserting, by the processor, the set of potential transactions into the optimization engine except for one potential transaction of the set of potential transactions;
executing, by the processor, the optimization engine with the set of potential transactions except for the one potential transaction; and
determining, by the processor from the optimization engine based on the executing, an effect of the one potential transaction.

3. The method of claim 2, wherein the determining the effect of the one potential transaction comprises determining a difference between an output of the optimization engine with the set of potential transactions except for the one potential transaction as input and an output of the optimization engine with each potential transaction of the set of potential transactions as input.

4. The method of claim 1, further comprising:
transmitting, by the processor, the record comprising the rankings for the set of potential transactions to a client device,
wherein the client device displays the rankings for the set of potential transactions on a user interface.

5. The method of claim 4, further comprising:
receiving, by the processor, a selection of a subset of the set of potential transactions from the client device; and
responsive to receiving the selection of the subset of the set of potential transactions, executing, by the processor, the optimization engine based on the subset of potential transactions.

6. The method of claim 5, further comprising:
receiving, by the processor from one or more computing devices, a set of available transactions;
extracting, by the processor, one or more attributes of the set of available transactions;
comparing, by the processor, the one or more attributes of the set of available transactions with one or more attributes of the set of potential transactions; and
identifying, by the processor, one or more matching transactions between the set of available transactions and the set of potential transactions based on the comparison.

7. The method of claim 6, wherein executing the optimization engine based on the subset of potential transactions comprises:
identifying, by the processor, one or more available transactions that match the subset of potential transactions; and
executing, by the processor, the optimization engine using the one or more available transactions as input.

8. The method of claim 7, further comprising:
transmitting, by the processor, a second record comprising a subset of available transactions of the set of available transactions according to the executing the optimization engine using the one or more available transactions as input.

9. The method of claim 6, wherein comparing the one or more attributes of the set of available transactions with the one or more attributes of the set of potential transactions comprises:
executing, by the processor, a machine learning model using the one or more attributes of the set of available transactions and the one or more attributes of the set of potential transactions as input, the machine learning model trained to output a likelihood of a match between a potential transaction and an available transaction; and
determining, by the processor, the one or more matching transactions based on an output of the machine learning model based on the executing the machine learning model.

10. The method of claim 6, wherein determining the one or more matching transactions comprises:
comparing, by the processor, a likelihood of a match between a potential transaction and an available transaction to a threshold; and
determining, by the processor, a matching transaction between the potential transaction and the available transaction responsive to determining the likelihood exceeding the threshold.

11. The method of claim 6, wherein comparing the one or more attributes of the set of available transactions with the one or more attributes of the set of potential transactions comprises:
comparing, by the processor, a transaction identifier of an available transaction with a transaction identifier of a potential transaction; and
determining, by the processor, a matching transaction between the available transaction and the potential transaction based on the comparing the transaction identifier of the available transaction with the transaction identifier of the potential transaction.

12. The method of claim 11, wherein determining the matching transaction between the available transaction and the potential transaction comprises determining, by the processor, the transaction identifier of the available transaction is identical to the transaction identifier of the potential transaction.

13. The method of claim 4, wherein the client device displays the rankings for the set of potential transactions in a spreadsheet or a table.

14. A system, the system comprising:
one or more processors configured by machine-readable instructions to:
store a plurality of potential transactions, each potential transaction comprising one or more transaction attributes;
receive a selection of a set of values for the one or more transaction attributes;
select, using an optimization engine, a set of potential transactions from the plurality of potential transactions according to an optimization function and the selection of the set of values;
detect a defined time on an internal clock maintained by the one or more processors;
responsive to detecting the defined time, iteratively execute the optimization engine removing a different potential transaction from the set of potential transactions for each execution; and
generate a record comprising a ranking for each potential transaction of the set of potential transactions according to the iterative executions.

15. The system of claim 14, wherein the one or more processors are configured to iteratively execute the optimization engine by, for each execution:
inserting the set of potential transactions into the optimization engine except for one potential transaction of the set of potential transactions;
executing the optimization engine with the set of potential transactions except for the one potential transaction; and
receiving, from the optimization engine based on the executing, an effect of the one potential transaction.

16. The system of claim 14, wherein the one or more processors are configured to:
transmit the record comprising the rankings for the set of potential transactions to a client device,
wherein the client device displays the rankings for the set of potential transactions on a user interface.

17. The system of claim 16, wherein the one or more processors are configured to:
receive a selection of a subset of the set of potential transactions from the client device; and
responsive to receiving the selection of the subset of the set of potential transactions, execute the optimization engine based on the subset of potential transactions.

18. A method, comprising:
storing, by a processor, a plurality of potential transactions, each potential transaction comprising one or more transaction attributes;
receiving, by the processor, a selection of a set of values for the one or more transaction attributes;
selecting, by the processor using a first optimization engine, a set of potential transactions from the plurality of potential transactions according to an objective function and the selection of the set of values;
transmitting, by the processor to a plurality of processors, the set of potential transactions, the processor transmitting one or more identifications of a different subset of potential transactions of the set of potential transactions to each of the plurality of processors;
executing, by each of the plurality of processors, a second optimization engine corresponding to the first optimization engine removing a potential transaction of the subset of potential transactions received by the processor for each iterative execution; and
generating, by the processor, a record comprising a ranking for each potential transaction of the set of potential transactions according to the iterative executions of each of the plurality of processors.

19. The method of claim 18, comprising:
receiving, by the processor, an effect of a potential transaction from each of the plurality of processors; and
ranking, by the processor, the set of potential transactions according to the effect of each of the set of potential transactions.

20. The method of claim 18, comprising:
transmitting, by the processor, the record comprising the rankings for the set of potential transactions to a client device,
wherein the client device displays the rankings for the set of potential transactions on a user interface.
